(19) United States
(12) Patent Application Publication
(10) Pub. No.: US 2026/0027836 A1
(43) Pub. Date: Jan. 29, 2026

(54) LIQUID EJECTION HEAD SUBSTRATE AND LIQUID EJECTION HEAD

(71) Applicant: CANON KABUSHIKI KAISHA, Tokyo (JP)

(72) Inventor: AKIO GOTO, Tokyo (JP)

(21) Appl. No.: 19/273,478

(22) Filed: Jul. 18, 2025

(30) Foreign Application Priority Data
Jul. 23, 2024 (JP) 2024-117603

(51) Int. Cl. B41J 2/21; B41J 2/14; B41J 2/16

(52) U.S. Cl. CPC B41J 2/2103; B41J 2/14056; B41J 2/14072; B41J 2/14112; B41J 2/1601; B41J 2/1626; B41J 2002/14491

(57) ABSTRACT

A liquid ejection head substrate is installed in a liquid ejection head that has a plurality of ejection nozzles for ejecting liquid. The liquid ejection head substrate includes: a plurality of element arrays configured with a plurality of functional elements which correspond to the ejection nozzles and are arranged into the plurality of element arrays placed side by side in an arrangement direction (the X direction) which intersects with an array direction (the Y direction) of the functional elements; and a dummy functional element array configured with a plurality of dummy functional elements which are not electrically driven and are arranged into the dummy functional element array along the array direction (the Y direction). The dummy functional element array is arranged at a side of the plurality of element arrays with respect to the arrangement direction (the X direction).

### BACKGROUND

### Field of the Technology

The present disclosure relates to a liquid ejection head substrate and a liquid ejection head.

### Description of the Related Art

As an example of a liquid ejection apparatus, there is an inkjet printing apparatus. An inkjet printing apparatus includes a liquid ejection head that ejects liquid such as ink. A liquid ejection head installed in an inkjet printing apparatus is also referred to as a print head. A print head includes an element substrate and a liquid chamber forming member (an orifice plate). In the liquid chamber forming member, a large number of ejection nozzles (ports) are formed. The liquid chamber forming member is bonded to the element substrate, thereby forming liquid flow paths (liquid chambers) that communicate with the ejection nozzles in the space made with the element substrate. In the element substrate, there are functional elements, such as ejection elements and ejection detection elements corresponding to the large number of ejection nozzles, and supply ports for supplying liquid to the liquid flow paths. The ejection elements are also referred to as ejection energy generating elements. The ejection elements include, for example, electrothermal conversion elements and piezoelectric elements. Electrothermal conversion elements use thermal energy, which is generated by the electrothermal conversion elements, to generate bubbles in the liquid, thereby ejecting the liquid from the ejection nozzles. Piezoelectric elements use kinetic energy, which is generated by deformation of the piezoelectric elements, thereby ejecting the liquid from ejection nozzles. Ejection detection elements detect behavior of the liquid in the liquid flow paths, such as ejection of the liquid from the ejection nozzles or non-ejection of the liquid.

The print head generates ejection energy from ejection elements such as electrothermal conversion elements and piezoelectric elements, thereby ejecting liquid from the ejection nozzles to print an image. By allocating multiple types of ink (liquid) to multiple ejection nozzle arrays in which ejection nozzles are arranged, it is possible to print a multi-color image using the print head. Note that the functional elements such as ejection elements and ejection detection elements are arranged substantially into arrays, so as to correspond to the ejection nozzle arrays in which the ejection nozzles are arranged. A functional element has a protective film formed to protect the functional element. A surface of the protective film is exposed to a liquid flow path, and functions as an operation portion that imparts ejection energy generated from ejection elements to the liquid. Moreover, the protective film functions as an insulating portion that insulates functional elements from the liquid.

In such a print head, to suppress a decrease in printing quality, it is required that the volume of liquid droplets ejected from each ejection nozzle is uniform. In order to make the volume of the liquid droplets uniform, it is preferable that the physical properties and shape of the functional elements corresponding to the respective ejection nozzles are also uniform. Japanese Patent Laid-Open No. S62-191156 discloses a technology in which, in a liquid jet print head that has a plurality of functional elements formed by etching, dummy functional elements that do not contribute to the ejection of liquid are arranged at both end portions of element arrays in which the plurality of functional elements are aligned. Accordingly, the dummy functional elements prevent the functional elements from being affected by the circulation of the etchant, which may act on both sides of the element arrays, and thus the shapes of the plurality of functional elements become uniform, enabling high-definition printing.

### SUMMARY

An object of the present disclosure is to provide a liquid ejection head substrate capable of performing high-definition printing.

A liquid ejection head substrate according to an embodiment of the present disclosure is installed in a liquid ejection head that has a plurality of ejection nozzles for ejecting liquid. The liquid ejection head substrate includes: a plurality of element arrays configured with a plurality of functional elements which correspond to the ejection nozzles and are arranged into the plurality of element arrays placed side by side in an arrangement direction which intersects with an array direction of the functional elements; and a dummy functional element array configured with a plurality of dummy functional elements which are not electrically driven and are arranged into the dummy functional element array along the array direction. The dummy functional element array is arranged at a side of the plurality of element arrays with respect to the arrangement direction.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a liquid ejection head;

FIG. 2 is a plan view of an element substrate according to the first embodiment;

FIG. 3 is an enlarged plan view illustrating a part of the element substrate;

FIG. 4 is a cross-sectional view taken along the line IV-IV of FIG. 3;

FIG. 5 is a block diagram schematically illustrating electrical connections in the element substrate;

FIG. 6 is a plan view schematically illustrating an element substrate according to the second embodiment; and

FIG. 7 is a plan view schematically illustrating an element substrate according to the third embodiment.

### DESCRIPTION OF THE EMBODIMENTS

Hereinafter, a detailed description is given of preferable embodiments of the present disclosure with reference to the accompanying drawings. Note that the following embodiments are not intended to limit the contents of the present disclosure, and every combination of the characteristics described in the following embodiments is not necessarily essential to the solutions provided in the present disclosure. Note that the same configurations are described with the same signs.

### First Embodiment

### Configuration of the Liquid Ejection Head

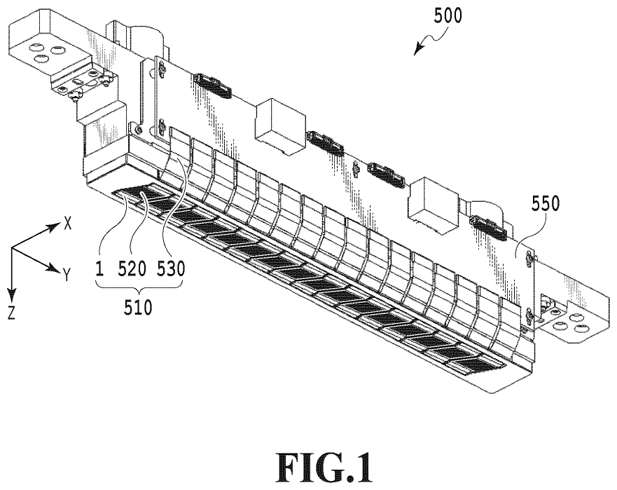

FIG. 1 is a perspective view of the liquid ejection head 500 in which a liquid ejection head substrate according to the present embodiment is used. Note that in the following description, the liquid ejection head substrate is referred to as the element substrate 1. The array direction in which the ejection elements installed in the element substrate 1 are arranged is defined as the Y direction, and the direction orthogonal to the array direction of the ejection elements is defined as the X direction. Further, the direction in which the liquid is ejected from the element substrate 1 is defined as the Z direction. In a case where a plurality of ejection nozzle arrays is formed in the liquid ejection head (the print head), a plurality of element arrays corresponding to the plurality of ejection nozzle arrays is formed in the element substrate. In such a case, the accuracy of dimensions of the element arrays located at end portions of the element substrate decreases compared to the element arrays located at the center of the element substrate, which may result in a decrease in printing quality. In the present embodiment, a description is given about a configuration capable of performing high-definition printing.

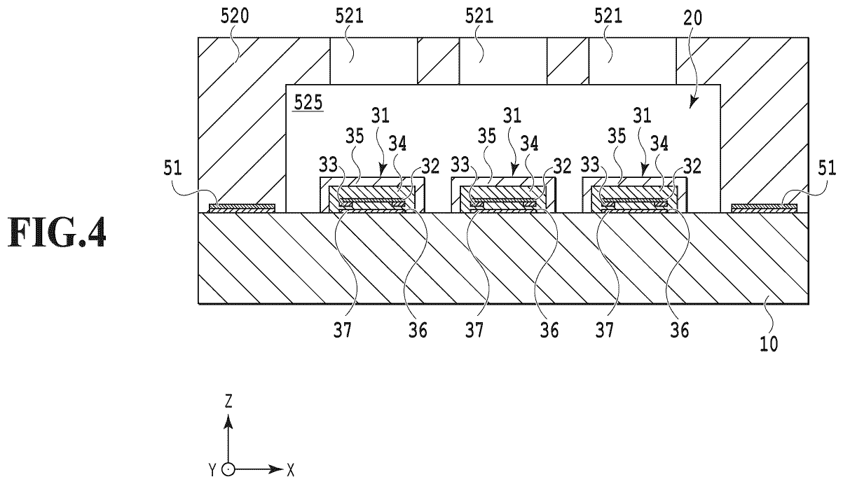

As illustrated in FIG. 1, the liquid ejection head 500 has an array of multiple liquid ejection modules 510 arranged in a line in the longitudinal direction (the Y direction). Each liquid ejection module 510 includes the element substrate 1, the liquid chamber forming member 520 (see FIG. 4), and the flexible wiring substrate 530 for supplying electric power to the ejection elements installed on the element substrate 1. The flexible wiring substrates 530 are commonly connected to the electric wiring substrate 550, on which a power supply terminal, an ejection signal input terminal, and the like are arranged. Note that the liquid ejection modules 510 can be easily attached to and detached from the liquid ejection head 500. The liquid ejection head 500 is capable of ejecting multiple types of ink from the ejection nozzles 521 (see FIG. 4) of the liquid chamber forming member 520. Note that the liquid ejection head 500 is not limited to ejecting ink, and may also eject a liquid such as a primer.

### Configuration of the Liquid Ejection Head Substrate

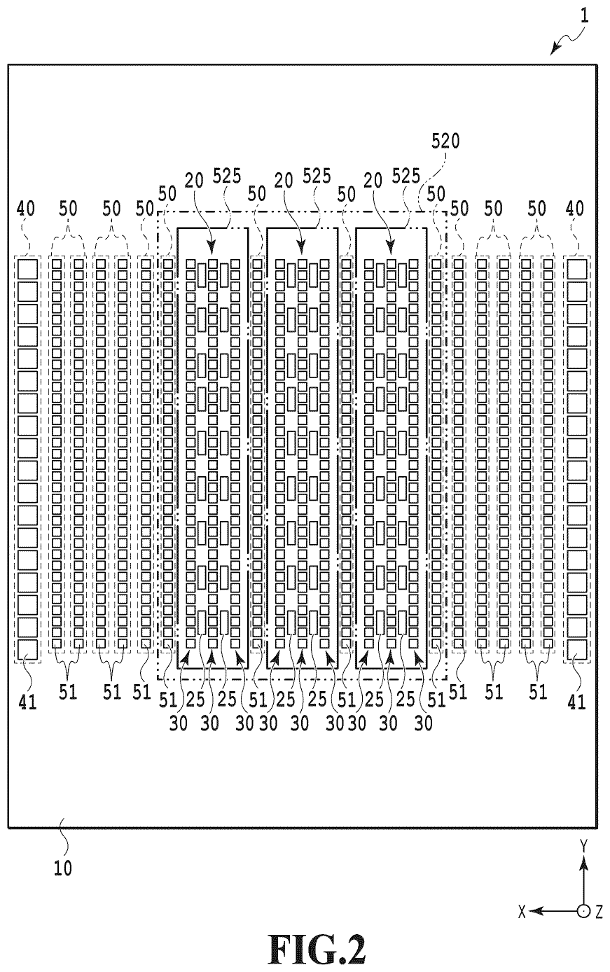

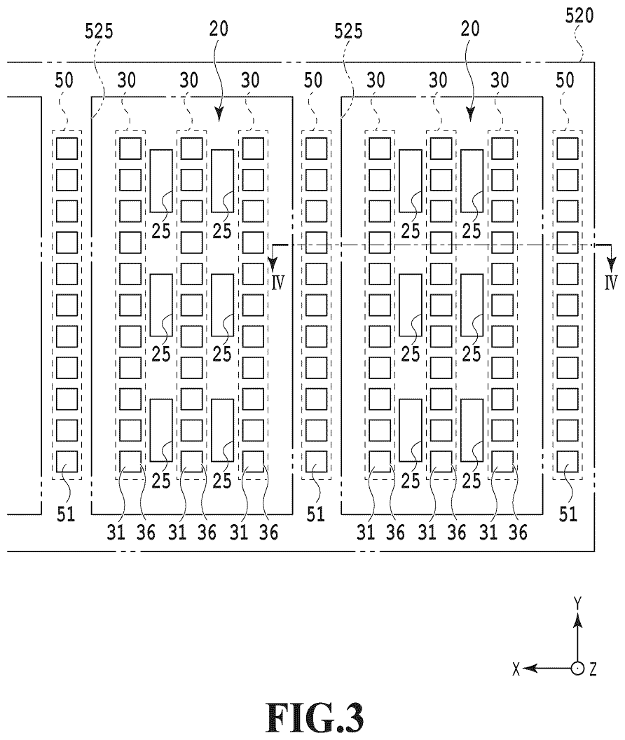

Next, a description is given about the element substrate 1 (the liquid ejection head substrate). FIG. 2 is a plan view of the element substrate 1 according to the first embodiment. FIG. 3 is an enlarged plan view illustrating a portion where the ejection elements and dummy functional elements are arranged in the element substrate 1. FIG. 4 is a cross-sectional view taken along the line IV-IV of FIG. 3. Note that the vertical relationship described below indicates a relative positional relationship in the cross section of the element substrate 1. If the mounting orientation of the element substrate 1 is reversed, the vertical relationship is also reversed.

As illustrated in FIG. 2, the element substrate 1 is formed so as to have a rectangular outer shape. The element substrate 1 includes the silicon substrate 10, the three element units 20, the two external connection terminal arrays 40 in which a plurality of external connection terminals 41 is arranged, and the plurality of dummy functional element arrays 50 in which a plurality of dummy functional elements 51 is arranged. The silicon substrate 10 is formed using a disk-shaped single crystal silicon substrate. After forming thin films on a disk-shaped silicon substrate, the substrate is cut out by blade dicing to produce the silicon substrate 10 that has a rectangular shape. Note that the silicon substrate 10 may have a substrate heating layer (not illustrated in the drawings) for heating the element substrate 1. The substrate heating layer includes a heat generating resistor that converts electric power into thermal energy, thereby heating the element substrate 1. The substrate heating layer (the heat generating resistor) is formed of tantalum silicon nitride (TaSiN), polysilicon, or the like.

On one surface (+Z direction side) of the element substrate 1 (the silicon substrate 10), the liquid chamber forming member 520 is formed (see also FIG. 4). The liquid chamber forming member 520 is formed in a box shape that covers one surface of the silicon substrate 10 and extends in the Y direction. As illustrated in FIG. 4, the liquid chamber forming member 520 forms the liquid chamber 525, which communicates with the ejection nozzles 521 formed in the liquid chamber forming member 520, in the space made with the element substrate 1. The liquid chamber forming member 520 is preferably made of a photosensitive resin. This makes it possible to easily form a pattern such as ejection nozzles in the liquid chamber forming member 520 using photolithography. In the example illustrated in FIG. 4, the liquid chamber forming member 520 is formed of a photosensitive resin, and the ejection nozzles 521 and the liquid chamber 525 are formed in the liquid chamber forming member 520 using a photolithography method. In a case where the liquid chamber 525 is formed by photolithography, a flow path mold member (not illustrated in the drawings) that serves as a mold of a flow path is formed using a material that can be dissolved by a solvent or a dissolving agent. Then, after forming the liquid chamber forming member 520 on the flow path mold member, the liquid chamber 525 that serves as a liquid flow path communicating with the ejection nozzles 521 can be formed by removing the flow path mold member. The liquid chamber forming member 520 may be formed of a metal material or an inorganic material, instead of a resin material. An example of the metal material used for the liquid chamber forming member 520 is a stainless-steel plate. Examples of the inorganic material used for the liquid chamber forming member 520 include silicon (Si), silicon nitride (SiN), silicon carbide (SiC), silicon carbonitride (SiCN), etc.

Further, the liquid chamber forming member 520 is not limited to a single layer, and may have multiple layers. In a case where the liquid chamber forming member 520 has multiple layers, an adhesion layer that improves adhesion to the silicon substrate 10 may be formed as the lowermost layer of the liquid chamber forming member 520. In a case where the silicon substrate 10 has multiple layers, an adhesive layer that improves adhesion to the liquid chamber forming member 520 may be formed as the uppermost layer of the silicon substrate 10.

In the liquid chamber forming member 520, a plurality of ejection nozzles 521 for ejecting ink is formed. Each ejection nozzle 521 is formed so as to correspond to each ejection element 31 of the element substrate 1 (the element units 20) and to communicate with the liquid chamber 525. Note that the expression “each ejection nozzle 521 corresponding to each ejection element 31” indicates that the ejection element 31 contributing to ejection from a given one of the ejection nozzles 521 is arranged so as to face that ejection nozzle 521. Further, the expression “each ejection nozzle 521 corresponding to each ejection element 31” may instead indicate that the center position of the ejection element 31 contributing to ejection from a given one of the ejection nozzles 521 is displaced, in a direction parallel to the surface of the substrate, from the center position of that ejection nozzle 521 in accordance with a predetermined rule.

As illustrated in FIG. 2 and FIG. 3, the element units 20 are arranged in a portion (the liquid chambers 525) surrounded by the liquid chamber forming member 520 on one surface (+Z direction side) of the silicon substrate 10. In the present embodiment, the three element units 20 and three liquid chambers 525 are formed so as to correspond to three types of ink. The three liquid chambers 525 are formed side by side in the X direction, isolated from one another, and extend in the Y direction in the shape of rectangular parallelepipeds. In the present embodiment, the X direction is the direction parallel to the short sides of the (rectangular) outer shape of the element substrate 1. The Y direction is the direction parallel to the long sides of the (rectangular) outer shape of the element substrate 1.

Each element unit 20 has a plurality of the supply ports 25 and the three element arrays 30 in which a plurality of the ejection elements 31 and ejection detection elements 36 are arranged as functional elements. The supply ports 25 are formed so as to penetrate the silicon substrate 10 in the Z direction, and are connected to an ink tank (not illustrated in the drawings) that stores ink and to the liquid chamber 525. For example, the supply ports 25 in the shape of a through hole are formed in the silicon substrate 10 by crystal anisotropic etching using a chemical solution, dry etching using plasma, or the like. Examples of the chemical solution used in the crystal anisotropic etching include an aqueous solution of tetramethylammonium hydroxide (TMAH), an aqueous solution of potassium hydroxide (KOH), etc. Further, the supply ports 25 are arranged side by side in the Y direction in the gaps formed by the three element arrays 30 arranged side by side in the X direction in each element unit 20.

The ejection elements 31 and ejection detection elements 36 that constitute the element arrays 30 are arranged in the direction (the Y direction) parallel to the long sides of the (rectangular) outer shape of the element substrate 1. This allows the area of the element substrate 1 to be used efficiently. The three element arrays 30 of each element unit 20 are arranged side by side in the X direction that intersects with (specifically, is orthogonal to) the array direction of the ejection elements 31 and ejection detection elements 36. Accordingly, the ejection elements 31 and ejection detection elements 36 are arranged in the shape of a matrix in each element unit 20.

As illustrated in FIG. 4, the ejection elements 31 are arranged in the liquid chamber 525 so as to face the ejection nozzles 521 of the liquid chamber forming member 520. Each ejection element 31 includes the heating resistor layer 32, the wiring layer 33, the protective layer 34, and the upper protective layer 35. Each ejection element 31 is an electrothermal conversion element formed by connecting the wiring layer 33 to the heating resistor layer 32. For example, the wiring layer 33, which is formed to overlap the heating resistor layer 32 on a thin film, is partially removed to form a gap, so that the heating resistor layer 32 located at the gap is exposed, thereby forming a heating unit of each ejection element 31. Each ejection element 31 converts electric power into thermal energy to generate bubbles in the ink inside the liquid chamber 525, thereby ejecting ink from the ejection nozzle 521. The ink supplied from an ink tank (not illustrated in the drawings) to the liquid chamber 525 via the supply ports 25 is ejected from the ejection nozzles 521 due to thermal energy applied by the ejection elements 31.

The heating resistor layer 32 is formed of tantalum silicon nitride (TaSiN) or the like. For example, after forming a TaSiN film, a mask pattern is formed by photolithography, and unnecessary part is removed by wet etching or dry etching, thereby forming the heating resistor layer 32.

The wiring layer 33 constitutes wiring that electrically connects the heating resistor layer 32 and the external connection terminals 41. The wiring layer 33 is formed of a conductive material. Examples of the conductive material used for the wiring layer 33 include metals such as aluminum (Al) and alloys containing aluminum as a main component such as aluminum-copper (Al—Cu) alloys. The wiring layer 33 is formed so as to extend from the heating resistor layer 32 to the X-direction end portions of the silicon substrate 10. At the tips of the wiring layer 33 located at the end portions of the silicon substrate 10, the external connection terminals 41 electrically connected to the flexible wiring substrate 530 (see FIG. 1) are formed. Accordingly, since the external connection terminals 41 are arranged at the end portions of the silicon substrate 10, the electrical connection to the outside can be easily made using the flexible wiring substrate 530, etc.

Note that the external connection terminals 41 do not need to be arranged at the end portions of the silicon substrate 10, and may instead be arranged at any portion of the silicon substrate 10 where electrical connection to the outside is easily made. For example, in a case where the wiring layer 33 extends to the other surface (−Z direction side) of the silicon substrate 10 via a through hole (not illustrated in the drawings), the external connection terminals 41 may be arranged on the surface of the silicon substrate 10 opposite to the surface where the ejection elements 31 are arranged. Further, the wiring layer 33 may also serve as wiring that electrically connects functional elements other than the ejection elements 31, such as the ejection detection elements 36, to the external connection terminals 41, and may also serve as wiring that electrically connects the later-described dummy functional elements 51 to the external connection terminals 41. The wiring layer connected to the functional elements other than the ejection elements 31 and the wiring layer connected to the dummy functional elements 51 may be laminated as layers different from the wiring layer 33 connected to the heating resistor layer 32.

In the example illustrated in FIG. 4, the wiring layer 33 is formed below the heating resistor layer 32 in FIG. 4, but may instead be formed above the heating resistor layer 32. Further, the wiring layer 33 may be connected to the heating resistor layer 32 via an insulating film laminated above or below the heating resistor layer 32. In this case, the heating resistor layer 32 and the wiring layer 33 may be electrically connected by a conductive connecting member that is inserted into the insulating film. Note that, in order to make the volume of liquid droplets (ink droplets) ejected from the ejection nozzles 521 uniform, it is preferable that the ejection elements 31 are planar. Therefore, it is preferable that no wiring pattern is arranged directly below or in the vicinity of the ejection elements 31. In a case where a wiring pattern is placed directly below and in the vicinity of the ejection elements 31 in order to reduce the size of the element substrate 1, it is necessary to eliminate the influence resulting from the presence of the step formed by the wiring pattern. Therefore, it is preferable that the wiring and each layer underlying the ejection elements 31 are planarized by a process such as CMP (chemical mechanical polishing) or etch-back.

Further, a selection circuit (not illustrated in the drawings) for selecting ejection elements 31 to be driven is installed in a portion of the wiring layer 33 between the heating resistor layer 32 and the external connection terminals 41. This selection circuit may be installed outside the silicon substrate 10 and connected to the ejection elements 31 (the heating resistor layer 32) via the external connection terminals 41. The ejection elements 31 are installed on the silicon substrate 10. Installing the ejection elements 31 on the silicon substrate 10 is not limited to installing the ejection elements 31 in contact with the surface of the silicon substrate 10. For example, the ejection elements 31 may be installed on the silicon substrate 10 via a thin film or the like, or the ejection elements 31 may be installed on the inner side of the silicon substrate 10. Further, a heat storage layer (not illustrated in the drawings) that is in contact with the silicon substrate 10 and prevents heat from escaping may be installed as the lowermost layer of the ejection elements 31. The heat storage layer is formed of a silicon oxide film (a SiO film), a boron phosphorus silicate glass film (a BPSG film), or the like. The ejection elements 31 may include the later-described ejection detection layer 37 to have the function of the ejection detection elements 36 which detect the behavior of liquid.

The protective layer 34 is installed between the heating resistor layer 32/the wiring layer 33 and the ejection detection layer 37, and between the heating resistor layer 32 and the upper protective layer 35. The protective layer 34 is formed of a SiO film, a SiN film, or the like, and functions as an insulating layer. The protective layer 34 may be formed as a single layer, or may be formed by laminating multiple layers. The protective layer 34 formed by laminating multiple layers is formed by a film formation method such as chemical vapor deposition (CVD) using plasma or sputtering deposition. Further, for the patterning of the protective layer 34, etching using a photoresist mask is employed.

The upper protective layer 35 is installed on the front surface of the protective layer 34. The upper protective layer 35 covers the surface of the protective layer 34, thereby protecting the ejection elements 31 from chemical and physical influences caused by bubbling of the ink (liquid). The upper protective layer 35 is formed, for example, of a chemically and physically strong metal film such as tantalum (Ta) or iridium (Ir). The upper protective layer 35 may be formed as a single layer, or may be formed by laminating multiple layers. The upper protective layer 35 formed by laminating multiple layers is formed by a film forming method such as chemical vapor deposition or sputter deposition, as in the case of the protective layer 34. Further, for the patterning of the upper protective layer 35, etching using a photoresist mask is employed. If the ejection elements 31 can be protected from the chemical and physical influences caused by bubbling of ink by the protective layer 34 alone, the upper protective layer 35 does not need to be installed.

The ejection detection elements 36 detect the behavior of the ink (liquid), which is ejected from the ejection nozzles 521 by the ejection elements 31. The ejection detection elements 36 have the ejection detection layer 37. The ejection detection layer 37 is installed between the silicon substrate 10 and the protective layer 34 of the ejection elements 31. In this manner, the ejection detection elements 36 are arranged at the same positions as the ejection elements 31 on the silicon substrate 10.

The ejection detection layer 37 is formed, for example, by laminating a titanium layer and a titanium nitride layer. The width of the portion of the ejection detection layer 37 that overlaps with the heating resistor layer 32 (the heating unit) is narrower than the width of the other portions of the ejection detection layer 37. Further, the ejection detection layer 37 is electrically connected to the external connection terminals 41 via another wiring layer (not illustrated in the drawings) that is electrically independent from the wiring layer 33 of the ejection elements 31. As with the ejection elements 31, in a case where a wiring pattern is installed directly below and in the vicinity of the ejection detection layer 37, it is necessary to eliminate the influence resulting from the presence of the step formed by the wiring pattern. Therefore, it is preferable that the wiring and each layer underlying the ejection detection elements 36 are planarized by a process such as CMP (chemical mechanical polishing) or etch-back. Further, similarly to the heating resistor layer 32, a mask pattern is formed by photolithography, and unnecessary part is removed by wet etching or dry etching, thereby forming the ejection detection layer 37.

In the present embodiment, the ejection detection elements 36 are arranged at the same positions as the ejection elements 31 on the silicon substrate 10; however, there is no limitation as such. For example, the ejection detection elements 36 may be arranged at positions different from the ejection elements 31 on the silicon substrate 10. In the present embodiment, the ejection detection layer 37 of the ejection detection elements 36 is installed between the silicon substrate 10 and the protective layer 34 of the ejection elements 31; however, there is no limitation as such. For example, the ejection detection layer 37 may be installed between the heating resistor layer 32 of the ejection elements 31 and the protective layer 34. The ejection detection layer 37 may be installed at a position distant from the surface of the silicon substrate 10 as long as it is in the vicinity of the ejection elements 31. In a case where the ejection detection layer 37 is distant from the surface of the silicon substrate 10, the ejection detection layer 37 may be formed on the same plane as the heating resistor layer 32.

The ejection detection layer 37 is formed of a metal material or an inorganic material with a physical property that changes its electrical resistance value depending on temperature. The ejection detection layer 37 may be formed as a single layer, or may be formed by laminating multiple layers. The material used for the ejection detection layer 37 is preferably a material with a large ratio of change in electrical resistance value in accordance with temperature relative to the resistivity. An example of the metal material used for the ejection detection layer 37 is an aluminum-copper (Al—Cu) alloy. Examples of the inorganic material used for the ejection detection layer 37 include titanium (Ti), titanium nitride (TiN), and tantalum silicon nitride (TaSiN).

In a case where the ejection detection layer 37 is a conductor, the ejection detection layer 37 itself may be used as wiring. For example, the ejection detection elements 36 may be formed by thinning desired portions of the ejection detection layer 37. Further, another wiring layer that is electrically independent from the wiring layer 33 of the ejection elements 31 may be connected to the ejection detection elements 36. For example, another wiring layer electrically independent from the wiring layer 33 is connected to a portion of the ejection detection elements 36 excluding the portion that changes in temperature. The said another wiring layer exhibits a smaller change in electric resistance value depending on temperature than the ejection detection layer 37, and has higher electrical conductivity than the ejection detection layer 37. Accordingly, the proportion of the change in electric resistance value depending on temperature relative to the overall electric resistance can be increased, thereby making it easier for the ejection detection elements 36 to detect the behavior of the liquid.

In a case where the heating resistor layer 32 of the ejection elements 31 has a thin film-like shape, the temperature change is greatest in the central portion of the heating resistor layer 32. Therefore, it is preferable that the ejection detection layer 37 is installed at least directly above or directly below the central portion of the heating resistor layer 32. Further, by increasing the resistance of the ejection detection layer 37, minute temperature changes can be detected as larger changes, thereby improving the SN ratio of the output signals from the ejection detection elements 36 and making it easier to detect the behavior of the liquid. For example, by using, as the material for the ejection detection layer 37, a material with a physical property that the electrical resistance value changes more significantly depending on temperature, the resistance of the ejection detection layer 37 can be increased. By narrowing the width of the ejection detection layer 37, the resistance of the ejection detection layer 37 can be increased. By forming the shape of the ejection detection layer 37 into a meandering shape in the plane directly above or directly below the heating resistor layer 32, the electrical length of the ejection detection layer 37 is extended, thereby allowing the resistance of the ejection detection layer 37 to be increased.

If electric power is supplied to the ejection detection layer 37 of the ejection detection elements 36 via the external connection terminals 41, a voltage or current that varies with a change in electrical resistance value depending on temperature is output from the ejection detection layer 37. By processing the variation in the output signals of the ejection detection elements 36 (the ejection detection layer 37) output via the external connection terminals 41 using a circuit such as an amplifier installed in the printing apparatus main body (not illustrated in the drawings), it is possible to detect the behavior such as ejection or non-ejection of ink (liquid). The output signals from the ejection detection elements 36 may be processed using any one or a combination of the printing apparatus main body, a circuit installed on the element substrate 1, or a processing apparatus connected to the printing apparatus main body via a network.

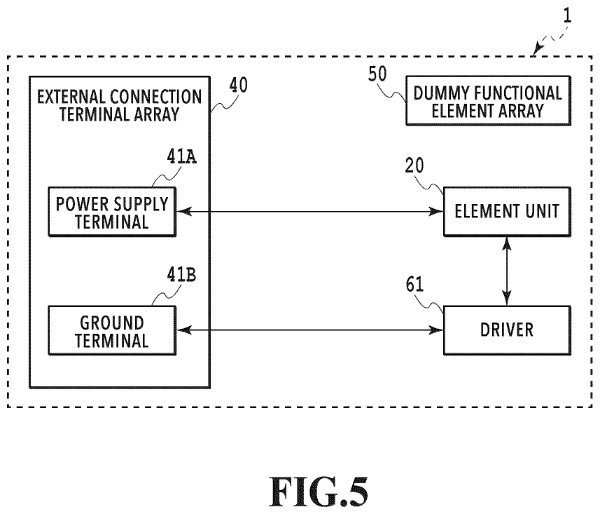

Note that the direction in which the element arrays 30 are arranged in the element units 20 is referred to as the arrangement direction. The direction in which the functional elements (the ejection elements 31 and the ejection detection elements 36) are arranged in the element arrays 30 is referred to as the array direction. In the present embodiment, the functional elements (the ejection elements 31 and the ejection detection elements 36) are linearly arranged into an array at an equal pitch; however, there is no limitation as such. For example, the functional elements may be arranged side by side into arrays in a staggered manner. Further, in a case where dpi (dots per inch) is not used as a unit of printing resolution (for example, in a case of designing in the metric system), the array pitch of the functional elements may not be equal. In a case where the liquid ejection head 500 ejects multiple types of ink (liquid), the liquid chamber forming member 520 is configured to form a plurality of the liquid chambers 525 that are isolated from one another for each color of ink. Due to the space required to form the multiple liquid chambers 525 in the liquid chamber forming member 520, the interval between adjacent element units 20 in the arrangement direction is greater than the interval between element arrays 30 of each element unit 20 in the arrangement direction. The interval between adjacent element units 20 in the arrangement direction, in other words, the interval between element arrays 30 located at the boundaries between adjacent element units 20 in the arrangement direction, is also referred to as an inter-color spacing. The area of the element substrate 1 excluding the element units 20 is also referred to as an car portion. In the car portion of the element substrate 1, the external connection terminal arrays 40, wiring (not illustrated in the drawings), the driver 61 (see FIG. 5), etc., may be arranged. The larger the area of the car portion on the element substrate 1 is, the smaller the area ratio of the element units 20 relative to the element substrate 1 becomes, and the accuracy of dimensions of the element arrays 30 (the functional elements) located near the end portions of the element substrate 1 in the element units 20 is likely to decrease. In the present embodiment, the element substrate 1 is formed in a rectangular (quadrangle) shape. Even if the element substrate 1 is formed in a polygonal shape with the corners of a rectangle rounded off, as long as the shape of the element units 20 is a rectangle, the accuracy of dimensions of the element arrays 30 located near the end portions of the element substrate 1 in the element units 20 is likely to decrease.

As illustrated in FIG. 2, the external connection terminal arrays 40 are arranged at both end portions of the element substrate 1 in the X direction (the arrangement direction of the element arrays 30). The external connection terminals 41 constituting the external connection terminal arrays 40 are arranged in the Y direction along the long sides of the (rectangle) outer shape of the element substrate 1. In other words, the external connection terminals 41 are arranged along the array direction of the functional elements (the ejection elements 31 and the ejection detection elements 36). The external connection terminals 41 are linearly arranged into arrays at an equal pitch; however, there is no limitation as such. For example, the external connection terminals 41 may be arranged side by side into arrays in a staggered manner. The arrangement pitch of the external connection terminals 41 does not have to be an equal pitch. Note that the arrangement along the outer shape of the element substrate 1 refers to an arrangement in which deviation from a straight line fitting the outer shape of the element substrate 1 is minimized. In the state where the plurality of external connection terminals 41 is electrically connected to the outside (the flexible wiring substrate 530), some of the multiple external connection terminals 41 function as power supply terminals 41A, and other parts of the multiple external connection terminals 41 function as ground terminals 41B. The power supply terminals 41A and the ground terminals 41B, which are included in the plurality of external connection terminals 41, are installed in numbers sufficient to supply necessary electric power to the element substrate 1. The external connection terminal arrays 40 may be arranged at the end portions on the long sides of the element substrate 1, or may be arranged at the end portions on the short sides of the element substrate 1. In a case where the external connection terminal arrays 40 are arranged at the end portions on the short sides of the element substrate 1, the width of the ear portion between the external connection terminal arrays 40 and the element units 20 becomes wider, thereby enhancing the effect resulting from arranging the dummy functional elements 51. Further, if the number of element arrays 30 increases, it becomes difficult to perform wiring across each functional element, starting from an external connection terminal array 40 installed on only one side of the element substrate 1. Therefore, by arranging the external connection terminal arrays 40 at both end portions of the element substrate 1, wiring can be easily performed from the external connection terminal arrays 40 installed at both end portions of the element substrate 1.

As illustrated in FIG. 2, the dummy functional element arrays 50 are arranged between each side with respect to the arrangement direction (the X direction) of the three element units 20, i.e., the nine element arrays 30, and the external connection terminal arrays 40. Moreover, the dummy functional element arrays 50 are arranged in the gaps between adjacent element units 20, i.e., in the gaps between element arrays 30 located at the boundaries of adjacent element units 20. For example, six dummy functional clement arrays 50 are each arranged side by side in the X direction between the three clement units 20 and the external connection terminal arrays 40 on both sides. One dummy functional element array 50 is arranged in each of the two arrays of gaps formed by the three element units 20. Further, for example, the elements in the group of 23 arrays, combining the element arrays 30 and the dummy functional element arrays 50, are each arranged in a matrix pattern (in a rectangular shape) at equal intervals.

The dummy functional elements 51 constituting the dummy functional element arrays 50 are arranged along the array direction (the Y direction) of the functional elements (the ejection elements 31 and the ejection detection elements 36). The dummy functional elements 51 are arranged into an array at the same arrangement pitch as the functional elements. Since the dummy functional elements 51 are arranged into an array at the same arrangement pitch as the functional elements, the density of the dummy functional elements 51 is equal to the density of the functional elements. The dummy functional elements 51 may be linearly arranged side by side at an equal pitch into an array or may be arranged side by side in a staggered manner into an array in accordance with the arrangement pitch of the functional elements. The arrangement pitch of the external connection terminals 41 does not have to be an equal pitch in accordance with the arrangement pitch of the functional elements. The dummy functional elements 51 have layers (the heating resistor layer 32 and the ejection detection layer 37) that function as functional elements, and are formed in the same size as the functional elements. However, the wiring for supplying electric power to the functional elements is not electrically connected to the dummy functional elements 51. Accordingly, the dummy functional elements 51 are not electrically driven, and thus do not function as functional elements. Note that the dummy functional elements 51 are not electrically connected to the electrodes of the functional elements (the ejection elements 31 and the ejection detection elements 36) or to the wiring connected to the electrodes, and thus the dummy functional elements 51 are not electrically driven. Further, the dummy functional elements 51 may instead be electrically connected to the electrodes of the functional elements or to the wiring connected to the electrodes, but not be selected by the selection circuit such as the driver 61 (see FIG. 5), so that the dummy functional elements 51 are not electrically driven. The dummy functional elements 51 do not function as functional elements, and thus do not serve as ejection elements that generate ejection energy and do not serve as ejection detection elements that detect the behavior of liquid. The dummy functional elements 51 are arranged so as not to face the liquid chambers 525, but may be arranged so as to face the liquid chamber 525 since they are not electrically driven.

In a case where the heating resistor layer 32 of the ejection elements 31 is formed by wet etching, due to the edge effect of etching, the dimensions of the heating resistor layer 32 located at the end portions of the element substrate 1 after the etching are different from those of the heating resistor layer 32 located at the central portion of the element substrate 1. Even in a case where the heating resistor layer 32 is formed by dry etching, the local opening ratios of the etching patterns are distributed differently between the central portion and the end portions of the element substrate 1, which results in variation in dimensions of the heating resistor layer 32 after the etching. In the present embodiment, at the time of forming the heating resistor layer 32, a layer corresponding to the heating resistor layer 32 of the dummy functional elements 51 that constitute the dummy functional element arrays 50 is formed on the sides with respect to the arrangement direction (the X direction) of the nine element arrays 30 in which the ejection elements 31 are arranged. Accordingly, instead of a decrease in the accuracy of dimensions of the dummy functional elements 51 that do not function as ejection elements 31, it is possible to suppress a decrease in the accuracy of dimensions of the ejection elements 31 (the heating resistor layer 32) located at both end portions (with respect to the X direction) of the element substrate 1. Further, at the time of forming the ejection detection layer 37, a layer corresponding to the ejection detection layer 37 of the dummy functional elements 51 that constitute the dummy functional element arrays 50 is formed on the sides with respect to the arrangement direction (the X direction) of the nine element arrays 30 in which the ejection detection elements 36 are arranged. Accordingly, instead of a decrease in the accuracy of dimensions of the dummy functional elements 51 that do not function as ejection detection elements 36, it is possible to suppress a decrease in the accuracy of dimensions of the ejection detection elements 36 (the ejection detection layer 37) located at both end portions (with respect to the X direction) of the element substrate 1. Therefore, uneven ejection caused by ununiformed shapes of the functional elements (the ejection elements 31 and the ejection detection elements 36) located at both end portions (with respect to the X direction) of the element substrate 1 can be suppressed, thereby enabling high-definition printing.

In a case where relatively large gaps (inter-color spacings) exist between adjacent element units 20, the accuracy of dimensions of the element arrays 30 located at both end portions (with respect to the X direction) of each element unit 20 (sandwiching the inter-color spacings) decreases. Therefore, in a case where a gap between adjacent element units 20 is at least twice as wide as the gaps between element arrays 30 within each element unit 20, dummy functional element arrays 50 may be arranged in the gap between the adjacent element units 20. For example, in a case where the gaps between element arrays 30 located at the boundaries of adjacent element units 20 are twice as wide as the gaps between element arrays 30 within each element unit 20, one dummy functional element array 50 may be arranged in each of the gaps between the element arrays 30 located at the boundaries of the adjacent element units 20. Accordingly, it is possible to suppress a decrease in the accuracy of dimensions of the functional elements (the ejection elements 31 and the ejection detection elements 36) located at the boundaries of the adjacent element units 20, which makes it possible to suppress uneven ejection caused by ununiformed shapes of the functional elements, thereby enabling high-definition printing. Note that the dummy functional elements 51 of the dummy functional element arrays 50 arranged in the gaps between the adjacent element units 20 are formed in the same manner as the dummy functional elements 51 of the dummy functional element arrays 50 arranged on the sides with respect to the arrangement direction (the X direction) of the three element units 20. Further, the gaps formed by the three element arrays 30 in each element unit 20 is the smallest among the gaps formed by the nine element arrays 30.

Next, with reference to FIG. 5, a description is given about the electrical connection between the element units 20 and the dummy functional element arrays 50. FIG. 5 is a block diagram schematically illustrating electrical connections of the element units 20 and the dummy functional element arrays 50 in the element substrate 1. As illustrated in FIG. 5, each of the functional elements (the ejection elements 31 and ejection detection elements 36) of the element units 20 and the driver 61 are electrically connected via wiring to the power supply terminal 41A and the ground terminal 41B that constitute the external connection terminals 41 of the external connection terminal arrays 40. On the other hand, each of the dummy functional elements 51 of the dummy functional element arrays 50 is not electrically connected to the power supply terminal 41A and the ground terminal 41B. The wiring connecting each functional element of the element units 20 to the power supply terminal 41A is wiring of a solid pattern that straddles each functional element. Note that each functional element of the element units 20 is electrically connected to the ground terminal 41B via the driver 61. The wiring connecting each functional element of the element units 20 to the ground terminal 41B via the driver 61 is wiring of a solid pattern that straddles each functional element and is formed on a wiring layer different from the wiring connected to the power supply terminal 41A. The power supply terminal 41A is an external connection terminal (41) for supplying electric power to each functional element of the element units 20 from the outside. The ground terminal 41B is an external connection terminal (41) that is electrically connected to the outside and serves as a reference potential. As described above, the power supply terminal 41A and the ground terminal 41B are installed in numbers sufficient to supply necessary electric power to the element substrate 1. The driver 61 is arranged in an area of the element substrate 1 other than the element units 20, the external connection terminal arrays 40, and the dummy functional element arrays 50. For example, the driver 61 may be arranged between the element units 20 and the Y-directional end portions of the element substrate 1, or may be arranged in the gaps between adjacent element units 20. The driver 61 is configured with a selection circuit for selecting ejection elements 31 that will perform ejection, from among the plurality of ejection elements 31 in the element units 20. The selection circuit constituting the driver 61 is configured with a transistor such as DMOS (Double-Diffused MOSFET).

Note that the driver 61 is not limited to a selection circuit and may include other circuits. Each functional element of the element units 20 may be electrically connected to the ground terminal 41B, or may be electrically connected to the power supply terminal 41A via the driver 61. In this case, a ground terminal for the driver 61 may be installed in addition to the ground terminal 41B for each functional element. If the dummy functional elements 51 are not connected to the power supply terminal 41A of the external connection terminal arrays 40, the dummy functional elements 51 may be electrically connected to the ground terminal 41B. It is also possible that, while the dummy functional elements 51 are connected via the driver 61 to the power supply terminal 41A of the external connection terminal arrays 40, the driver 61 does not select electric power supply to the dummy functional elements 51.

As described above, according to the first embodiment, it is possible to perform high-definition printing. That is, in the present embodiment, the dummy functional element arrays 50 are arranged between each side with respect to the arrangement direction (the X direction) of the three element units 20, i.e., the nine element arrays 30, and the external connection terminal arrays 40. Accordingly, instead of a decrease in the accuracy of dimensions of the dummy functional elements 51 that do not function as functional elements, it is possible to suppress a decrease in the accuracy of dimensions of the functional elements (the ejection elements 31 and the ejection detection elements 36) located at the end portions (with respect to the X direction) of the element substrate 1. Therefore, uneven ejection caused by ununiformed shapes of the functional elements located at the end portions of the element substrate 1 can be suppressed. Moreover, the dummy functional element arrays 50 are arranged in the gaps between adjacent element units 20, i.e., in the gaps between element arrays 30 located at the boundaries of adjacent element units 20. The gaps between the element arrays 30 located at the boundaries of adjacent element units 20 are gaps with a width equal to or greater than twice the minimum width among the gaps formed by the nine element arrays 30. Accordingly, it is possible to suppress a decrease in the accuracy of dimensions of the functional elements located at the boundaries of adjacent element units 20, thereby making it possible to suppress uneven ejection caused by ununiformed shapes of the functional elements. In this way, high-definition printing can be performed.

Further, the external connection terminal arrays 40 are installed at both end portions of the element substrate 1 with respect to the arrangement direction (the X direction). Accordingly, it is possible to perform wiring from the external connection terminal arrays 40 installed at both end portions of the element substrate 1.

Further, the functional elements (the ejection elements 31 and ejection detection elements 36) are arranged into arrays so as to be parallel to the long sides (or the short sides) of the (rectangular) outer shape of the element substrate 1. This allows the area of the element substrate 1 to be used efficiently.

### Second Embodiment

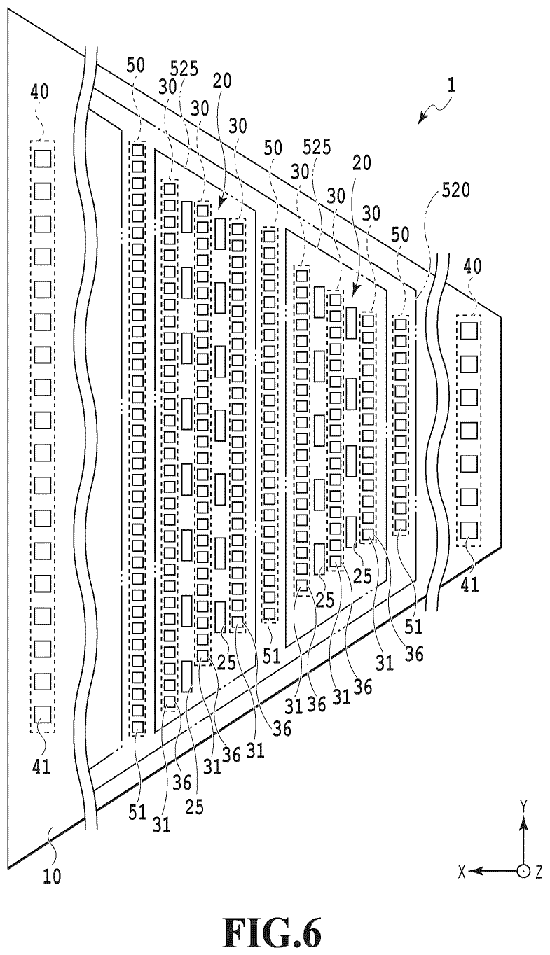

Next, a description is given about the second embodiment. Since each of the members in the second embodiment has the same configuration as in the above-described first embodiment, the description is given with the same signs as those in the above-described first embodiment. FIG. 6 is a plan view schematically illustrating the element substrate 1 (the liquid ejection head substrate) according to the second embodiment.

### Configuration of the Liquid Ejection Head Substrate

As illustrated in FIG. 6, the element substrate 1 according to the second embodiment is formed so as to have a trapezoid outer shape. After forming thin films on a disk-shaped silicon substrate, the silicon substrate 10 in a trapezoidal shape is formed by stealth dicing. In stealth dicing, laser light is focused inside a silicon substrate to form a pattern of a transformed layer to be locally processed, and then an external stress is applied to the silicon substrate to divide it. Since the element substrate 1 (the silicon substrate 10) has a trapezoidal outer shape, it is possible to produce a greater number of element substrates 1 from a disk-shaped silicon substrate, compared to a case in which the element substrate 1 has a rectangular outer shape.

In the second embodiment, the functional elements (the ejection elements 31 and ejection detection elements 36) that constitute the element arrays 30 are arranged into arrays in the direction (the Y direction) parallel to the base sides of the (trapezoid) outer shape of the element substrate 1. The three element arrays 30 of each element unit 20 are arranged side by side in the X direction that intersects (specifically, is orthogonal to) the array direction of the functional elements. Further, the three element arrays 30 of each element unit 20 may be arranged side by side in a direction that is parallel to any of the oblique sides of the (trapezoid) outer shape of the element substrate 1 and intersects with the array direction of the functional elements. Note that the three liquid chambers 525 are formed side by side in the X direction and extend in the Y direction in a trapezoidal shape.

The external connection terminal arrays 40 are arranged at both base-side end portions of the element substrate 1. The external connection terminals 41 constituting the external connection terminal arrays 40 are arranged into arrays in the Y direction along both base sides of the (trapezoid) outer shape of the element substrate 1. In other words, the external connection terminals 41 are arranged along the array direction of the functional elements (the ejection elements 31 and the ejection detection elements 36).

The dummy functional element arrays 50 are arranged between each side with respect to the arrangement direction (the X direction) of the three element units 20, i.e., the nine element arrays 30, and the external connection terminal arrays 40. Moreover, the dummy functional element arrays 50 are arranged in the gaps between adjacent element units 20, i.e., in the gaps between element arrays 30 located at the boundaries of adjacent element units 20. For example, six dummy functional element arrays 50 are each arranged side by side between the three element units 20 and the external connection terminal arrays 40 on both sides. One dummy functional element array 50 is arranged in each of the two arrays of gaps formed by the three element units 20. Further, for example, the elements in the 23 groups of arrays, combining the element arrays 30 and the dummy functional element arrays 50, are each arranged at equal intervals to form a trapezoidal shape. The arrangement direction of the element arrays 30 and the dummy functional element arrays 50 is the X direction that intersects (specifically, is orthogonal to) the array direction of the functional elements. Further, the arrangement direction of the element arrays 30 and the dummy functional element arrays 50 may be a direction that is parallel to any of the oblique sides of the (trapezoid) outer shape of the element substrate 1 and intersects with the array direction of the functional elements.

Accordingly, instead of a decrease in the accuracy of dimensions of the dummy functional elements 51 that do not function as functional elements, it is possible to suppress a decrease in the accuracy of dimensions of the functional elements (the ejection elements 31 and the ejection detection elements 36) located at the base-side end portions of the element substrate 1. Therefore, uneven ejection caused by ununiformed shapes of the functional elements located at the base-side end portions of the element substrate 1 can be suppressed, thereby enabling high-definition printing. Further, it is possible to suppress a decrease in the accuracy of dimensions of the functional elements located at the boundaries of adjacent element units 20, which makes it possible to suppress uneven ejection caused by ununiformed shapes of the functional elements, thereby enabling high-definition printing.

As described above, according to the second embodiment, it is possible to perform high-definition printing, as with the first embodiment.

In the second embodiment, the functional elements (the ejection elements 31 and ejection detection elements 36) are arranged so as to be parallel to the base sides of the (trapezoid) outer shape of the element substrate 1. Further, the external connection terminal arrays 40 are arranged at both base-side end portions of the element substrate 1. Accordingly, by aligning the element substrates 1 formed in a trapezoidal outer shape in the Y direction so that the upper bases and lower bases of the trapezoids are alternately connected, it is possible to implement a liquid ejection head in which a plurality of the element substrates 1 (liquid ejection modules) is arranged in an array in the Y direction.

### Third Embodiment

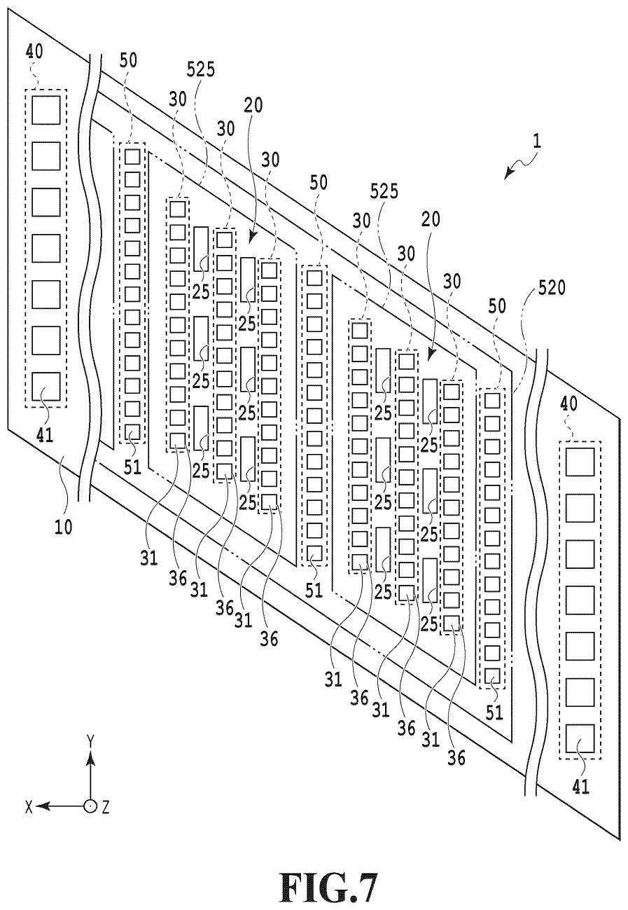

Next, a description is given about the third embodiment. Since each of the members in the third embodiment has the same configuration as in the above-described first embodiment, the description is given with the same signs as those in the above-described first embodiment. FIG. 7 is a plan view schematically illustrating the element substrate 1 (the liquid ejection head substrate) according to the third embodiment.

### Configuration of the Liquid Ejection Head Substrate

As illustrated in FIG. 7, the element substrate 1 according to the third embodiment is formed so as to have a parallelogram outer shape. As in the second embodiment, after forming thin films on a disk-shaped silicon substrate, the silicon substrate 10 in a parallelogram shape is formed by stealth dicing.

In the third embodiment, the functional elements (the ejection elements 31 and ejection detection elements 36) that constitute the element arrays 30 are arranged into arrays in the direction (the Y direction) parallel to a pair of opposite sides of the (parallelogram) outer shape of the element substrate 1. The three element arrays 30 of each element unit 20 are arranged side by side in the direction that is parallel to the other pair of opposite sides of the (parallelogram) outer shape of the element substrate 1 and intersects with the array direction of the functional elements. Note that the three liquid chambers 525 are formed side by side in the direction parallel to the other pair of opposite sides of the (parallelogram) outer shape of the element substrate 1, and extend in the Y direction in the shape of a parallelogram.

The external connection terminal arrays 40 are arranged at both end portions of a pair of opposite sides of the element substrate 1. The external connection terminals 41 constituting the external connection terminal arrays 40 are arranged into arrays in the Y direction along a pair of opposite sides of the (parallelogram) outer shape of the element substrate 1. In other words, the external connection terminals 41 are arranged along the array direction of the functional elements (the ejection elements 31 and the ejection detection elements 36).

The dummy functional element arrays 50 are arranged between each side with respect to the arrangement direction of the three element units 20, i.e., the nine element arrays 30, and the external connection terminal arrays 40. Moreover, the dummy functional element arrays 50 are arranged in the gaps between adjacent element units 20, i.e., in the gaps between element arrays 30 located at the boundaries of adjacent element units 20. For example, six dummy functional element arrays 50 are each arranged side by side between the three element units 20 and the external connection terminal arrays 40 on both sides. One dummy functional element array 50 is arranged in each of the two arrays of gaps formed by the three element units 20. Further, for example, the elements in the 23 groups of arrays, combining the element arrays 30 and the dummy functional element arrays 50, are each arranged at equal intervals to form a parallelogram shape. The arrangement direction of the element arrays 30 and the dummy functional element arrays 50 is parallel to the other pair of opposite sides of the (parallelogram) outer shape of the element substrate 1.

Accordingly, instead of a decrease in the accuracy of dimensions of the dummy functional elements 51 that do not function as functional elements, it is possible to suppress a decrease in the accuracy of dimensions of the functional elements (the ejection elements 31 and the ejection detection elements 36) located at the end portions of a pair of opposite sides of the element substrate 1. Therefore, uneven ejection caused by ununiformed shapes of the functional elements located at the end portions of a pair of opposite sides of the element substrate 1 can be suppressed, thereby enabling high-definition printing. Further, it is possible to suppress a decrease in the accuracy of dimensions of the functional elements located at the boundaries of adjacent element units 20, which makes it possible to suppress uneven ejection caused by ununiformed shapes of the functional elements, thereby enabling high-definition printing.

As described above, according to the third embodiment, it is possible to perform high-definition printing, as with the first embodiment.

In the third embodiment, the functional elements (the ejection elements 31 and ejection detection elements 36) are arranged into arrays parallel to a pair of opposite sides of the (parallelogram) outer shape of the element substrate 1. Further, the external connection terminal arrays 40 are arranged at both end portions of a pair of opposite sides of the element substrate 1. Accordingly, by aligning the element substrates 1 formed in a parallelogram outer shape in the Y direction so that a pair of opposite sides of each parallelogram shape is connected, it is possible to implement a liquid ejection head in which multiple element substrates 1 (liquid ejection modules) are arranged in an array in the Y direction.

In each of the above-described embodiments, the functional elements may include, in addition to the ejection elements 31 and the ejection detection elements 36, a resistor that heats the element substrate 1 by converting electric power into thermal energy. The resistor may be arranged at the same position as the ejection elements 31 on the silicon substrate 10 as a substrate heating layer for heating the element substrate 1, or may be arranged at a position different from the ejection elements 31 on the silicon substrate 10. Note that the dummy functional elements 51 do not function as functional elements, and thus do not serve as a resistor (the substrate heating layer) that heats the element substrate 1.

In each of the above-described embodiments, the external connection terminal arrays 40 are arranged on both end portions of the element substrate 1; however, there is no such limitation. For example, the external connection terminal arrays 40 may be arranged at one end portion of the element substrate 1. In this case, different numbers of dummy functional element arrays 50 may be arranged on the side of the nine element arrays 30 where the external connection terminal arrays 40 are arranged and the side of the nine element arrays 30 where the external connection terminal arrays 40 are not arranged.

In each of the above-described embodiments, the three element units 20 and three liquid chambers 525 corresponding to three types of ink are formed; however, there is no such limitation. For example, four element units 20 and four liquid chambers 525 corresponding to four types of ink may be formed, and it is only necessary that the number of element units 20 and liquid chambers 525 formed corresponds to the types of ink.

In each of the above-described embodiments, the ejection elements 31 are electrothermal conversion elements that eject ink (liquid) from the ejection nozzles 521 by generating bubbles in the liquid using thermal energy; however, there is no limitation as such. For example, the ejection elements may be piezoelectric elements that eject ink (liquid) from ejection nozzles by using kinetic energy generated by deformation.

In each of the above-described embodiments, the liquid ejection head 500 is what is termed as a full-line type liquid ejection head capable of ejecting ink across the whole area in the width direction of the print medium without moving in the main scanning direction; however, there is no limitation as such. The liquid ejection head may be what is termed as a serial type liquid ejection head that ejects ink while moving in the main scanning direction.

In each of the above-described embodiments, the silicon substrate 10 is formed using a single crystal silicon substrate; however, there is not limitation as such. For example, the silicon substrate 10 may be formed using an SOI (Silicon On Insulator) wafer in which an oxide film layer is sandwiched between two silicon layers, or may be formed using an annealed wafer whose surface has been modified by heat treatment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, high-definition printing can be performed.

This application claims the benefit of Japanese Patent Application No. 2024-117603, filed Jul. 23, 2024, which is hereby incorporated by reference herein in its entirety.

What is claimed is:

1. A liquid ejection head substrate installed in a liquid ejection head that has a plurality of ejection nozzles for ejecting liquid, the liquid ejection head substrate comprising:
a plurality of element arrays configured with a plurality of functional elements corresponding to the ejection nozzles, the plurality of functional elements being arranged into the plurality of element arrays placed side by side in an arrangement direction which intersects with an array direction of the functional elements; and
a dummy functional element array configured with a plurality of dummy functional elements not electrically driven, the plurality of dummy functional elements being arranged into the dummy functional element array along the array direction,
wherein the dummy functional element array is arranged at a side of the plurality of element arrays with respect to the arrangement direction.

2. The liquid ejection head substrate according to claim 1,
wherein the dummy functional element array is arranged at a side of the plurality of element arrays with respect to the arrangement direction and in a gap formed by the plurality of element arrays.

3. The liquid ejection head substrate according to claim 2,
wherein the gap formed by the plurality of element arrays is a gap with a width equal to or greater than twice the minimum width among the gaps formed by the plurality of element arrays.

4. The liquid ejection head substrate according to claim 1 further comprising
an external connection terminal array configured with a plurality of external connection terminals electrically connected to an outside, the plurality of external connection terminals being arranged into the external connection terminal array along the array direction,
wherein the external connection terminal array is installed at an end portion of the liquid ejection head substrate with respect to the arrangement direction, and
wherein the dummy functional element array is arranged between the side of the plurality of element arrays with respect to the arrangement direction and the external connection terminal array.

5. The liquid ejection head substrate according to claim 4,
wherein the external connection terminal array is installed at both end portions of the liquid ejection head substrate with respect to the arrangement direction.

6. The liquid ejection head substrate according to claim 1,
wherein the functional elements include an ejection element that generates ejection energy for ejecting the liquid from the ejection nozzles, and
wherein the dummy functional elements do not generate ejection energy.

7. The liquid ejection head substrate according to claim 6,
wherein the functional elements include an ejection detection element that detects behavior of liquid, and
wherein the dummy functional elements do not detect behavior of the liquid.

8. The liquid ejection head substrate according to claim 6,
wherein the functional elements include a resistor that heats the liquid ejection head substrate, and
wherein the dummy functional elements do not heat the liquid ejection head substrate.

9. The liquid ejection head substrate according to claim 1,
wherein an outer shape of the liquid ejection head substrate is formed in a rectangular shape, and
wherein the functional elements are arranged into the arrays in parallel with a long side or a short side of the rectangular shape.

10. The liquid ejection head substrate according to claim 1,
wherein an outer shape of the liquid ejection head substrate is formed in a trapezoidal shape, and
wherein the functional elements are arranged into the arrays in parallel with a base side of the trapezoidal shape.

11. The liquid ejection head substrate according to claim 1,
wherein an outer shape of the liquid ejection head substrate is formed in a parallelogram shape, and
wherein the functional elements are arranged into the arrays in parallel with a pair of opposite sides of the parallelogram shape.

12. The liquid ejection head substrate according to claim 1,
wherein wiring for supplying electric power to the functional elements is not electrically connected to the dummy functional elements.

13. The liquid ejection head substrate according to claim 1,
wherein a layer underlying the functional elements arranged into the arrays is planar.

14. A liquid ejection head substrate installed in a liquid ejection head that has a plurality of ejection nozzles for ejecting liquid, the liquid ejection head substrate comprising:
a plurality of element arrays configured with a plurality of functional elements corresponding to the ejection nozzles, the plurality of functional elements being arranged into the plurality of element arrays placed side by side in an arrangement direction which intersects with an array direction of the functional elements; and
a dummy functional element array configured with a plurality of dummy functional elements not electrically driven, the plurality of dummy functional elements being arranged into the dummy functional element array along the array direction,
wherein the dummy functional element array is arranged in a gap formed by the plurality of element arrays.

15. A liquid ejection head that has a plurality of ejection nozzles for ejecting liquid, the liquid ejection head comprising
a liquid ejection head substrate configured with
a plurality of element arrays configured with a plurality of functional elements corresponding to the ejection nozzles, the plurality of functional elements being arranged into the plurality of element arrays placed side by side in an arrangement direction which intersects with an array direction of the functional elements, and
a dummy functional element array configured with a plurality of dummy functional elements not electrically driven, the plurality of dummy functional elements being arranged into the dummy functional element array along the array direction,
wherein the dummy functional element array is arranged at a side of the plurality of element arrays with respect to the arrangement direction.
